(19) United States
(12) Patent Application Publication
(10) Pub. No.: US 2022/0122441 A1
(43) Pub. Date: Apr. 21, 2022

(54) MONITORING DEVICE, MONITORING METHOD, AND MONITORING PROGRAM

(71) Applicants: HITACHI, LTD., Tokyo (JP); HITACHI GLOBAL LIFE SOLUTIONS, INC., Tokyo (JP)

(72) Inventors: Katsuhito KOMURA, Tokyo (JP); Hiroyuki KOGANE, Tokyo (JP); Atsushi SAWAYAMA, Tokyo (JP)

(73) Assignees: HITACHI, LTD., Tokyo (JP); HITACHI GLOBAL LIFE SOLUTIONS, INC., Tokyo (JP)

(21) Appl. No.: 17/425,774

(22) PCT Filed: Feb. 6, 2020
(86) PCT No.: PCT/JP2020/004462

§ 371 Date: Jul. 26, 2021

(30) Foreign Application Priority Data
Mar. 7, 2019 (JP) 2019-041609

(51) Int. Cl. G08B 21/04

(52) U.S. Cl. CPC G08B 21/04

(57) ABSTRACT

A monitoring device of the invention includes a sensor information acquisition unit that receives information indicating that a monitored person is in a living room or information indicating that the monitored person is not in the living room from a sensor installed in the living room of the monitored person's house, and a sensor information processing unit that reviews information acquired by the sensor during night among the information indicating that the monitored person is not in the living room as information indicating that the monitored person is sleeping, and reviews again information satisfying a predetermined condition among the information indicating that the monitored person is sleeping as the information indicating that the monitored person is not in the living room.

### TECHNICAL FIELD

The present invention relates to a monitoring device, a monitoring method, and a monitoring program.

### BACKGROUND ART

In developed countries these days, the number of single elderly people is increasing with the declining birthrate and aging population. When a single elderly person has a child, the single elderly person often lives in a place away from the child. Therefore, it is a big concern for the child to not know how the parent is doing. Therefore, a system for knowing the state of a single elderly person living in a remote place has become widespread.

The life monitoring device of PTL 1 receives information of a monitored person detected by a motion sensor installed in the living room. The device recognizes the start, end, etc. of sleep of the monitored person by applying a predetermined threshold to the cumulative number of detection times of the monitored person within a predetermined period. That is, the device determines that sleep starts when the cumulative number of sensor reactions becomes sparse (there is no sensor reaction for 1 hour), and sleep ends at the time point when the cumulative number of sensor reactions becomes dense.

### CITATION LIST

### Patent Literature

PTL 1: JP 6145907 B1

### SUMMARY OF INVENTION

### Technical Problem

The life monitoring device of PTL 1 has a reduced accuracy of recognizing the start and end of sleep of the monitored person depending on the setting of the threshold. Further, the device simply determines that the monitored person is sleeping when the monitored person is not in the living room. That is, the device entrusts the monitoring person with a substantial judgment as to whether the monitored person was actually sleeping when he was not in the living room.

The monitoring person may want to know, for example, whether it means sleep or going out if the monitored person is not in the living room during night. In addition, the monitoring person may want to know whether it can be determined that the monitored person was sleeping before he/she temporarily waked up during night to go to the restroom or the like and stopped by the living room. It is difficult, of course, to completely meet the needs of such monitoring person. However, there is a demand for technology that can meet such needs as much as possible.

Therefore, an object of the invention is to accurately acquire the sleep time of a single person during night.

### Solution to Problem

A monitoring device of the invention includes a sensor information acquisition unit that receives information indicating that a monitored person is in a living room or information indicating that the monitored person is not in the living room from a sensor installed in the living room of the monitored person's house, and a sensor information processing unit that reviews information acquired by the sensor during night among the information indicating that the monitored person is not in the living room as information indicating that the monitored person is sleeping, and reviews again information satisfying a predetermined condition among the information indicating that the monitored person is sleeping as the information indicating that the monitored person is not in the living room.

Other means will be described in the form for carrying out the invention.

### Advantageous Effects of Invention

According to the invention, it is possible to accurately obtain the sleep time of a single person during night.

### BRIEF DESCRIPTION OF DRAWINGS

FIG. 1 is a diagram for explaining a configuration of an environment and a monitoring device of this embodiment.

FIGS. 2(a) and 2(b) are diagrams for explaining information acquired by a sensor.

FIG. 3 is a diagram illustrating an example of information from a sensor.

FIG. 4 is a diagram illustrating an example of state information.

FIG. 5 is a diagram for further explaining a second review.

FIG. 6 is a diagram illustrating an example of activity level information.

FIG. 7 is a flowchart of a current state display processing procedure.

FIG. 8 is a flowchart of a life rhythm/sleep time display processing procedure.

FIG. 9 is an example of a “current state” screen.

FIG. 10 is an example of an activity amount screen.

FIG. 11 is an example of a life rhythm screen.

FIG. 12 is an example of a sleep time screen.

### DESCRIPTION OF EMBODIMENTS

Hereinafter, a mode for carrying out the invention (referred to as “this embodiment”) will be described in detail with reference to drawings and the like. This embodiment is an example in which a child and his/her relatives watch over a single elderly person. However, the invention can be widely applied to an example in which one person watches over another person moving between a living room and a bedroom.

(Environment and Configuration of Monitoring Device)

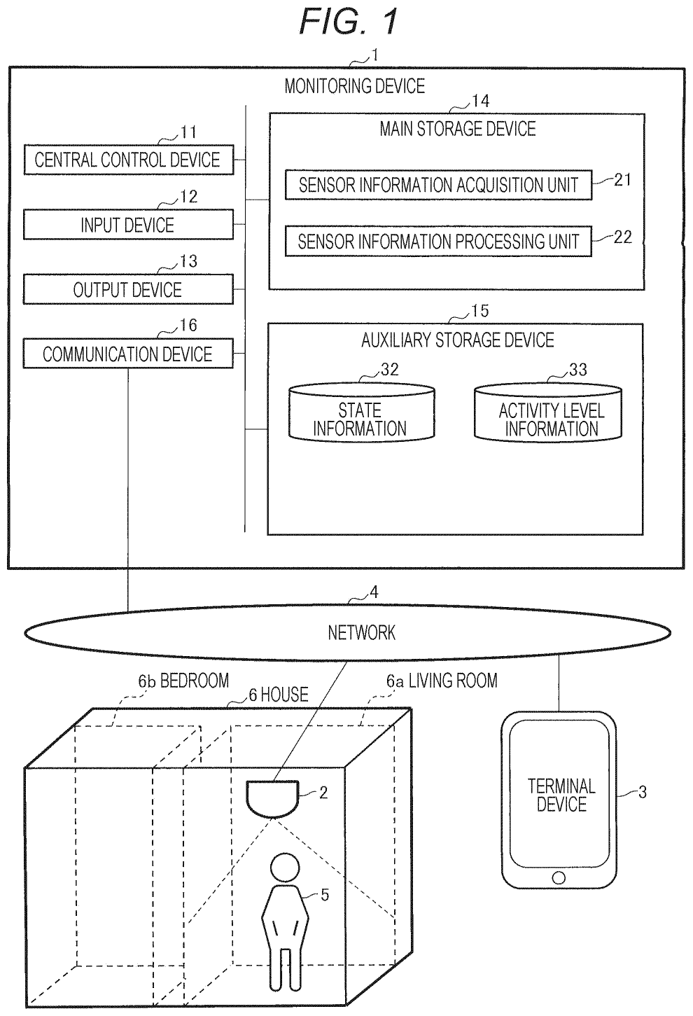

FIG. 1 is a diagram for explaining the environment of this embodiment and the configuration of a monitoring device. A monitored person 5 lives in a house 6. There are no residents in house 6 other than the monitored person 5, who is a single elderly person. The house 6 has a plurality of living rooms, including a living room 6a and a bedroom 6b. The living room 6a and the bedroom 6b are independent rooms with a corridor, a wall, etc. in between. The monitored person 5 spends the longest time in the living room 6a among the rooms other than the bedroom 6b. The monitored person 5 spends most of the day in the living room 6a and sleeps in the bedroom 6b during night when he/she is at home. Sensors (details below) are installed on the walls and ceiling of the living room 6a.

A monitoring device 1 is a general server and constitutes a monitoring service center. This center watches over a plurality of persons to be monitored in which the sensor 2 is arranged. This server includes a central control device 11, an input device 12 such as a mouse and a keyboard, an output device 13 such as a display, a main storage device 14, an auxiliary storage device 15, and a communication device 16. These are connected to each other by a bus. The auxiliary storage device 15 stores state information 32 and activity level information 33 (both described in detail later). A sensor information acquisition unit 21 and a sensor information processing unit 22 in the main storage device 14 are programs. The central control device 11 reads these programs from the auxiliary storage device 15 and loads them into the main storage device 14, thereby realizing the functions of the respective programs (details will be described later). The auxiliary storage device 15 may be configured independently of the monitoring device 1.

The monitoring device 1 is connected to a sensor 2 and a terminal device 3 via a network 4. The terminal device 3 of this embodiment is a portable computer operated by a monitoring person (not illustrated). However, the terminal device 3 may be a computer other than a portable computer.

(Sensor)

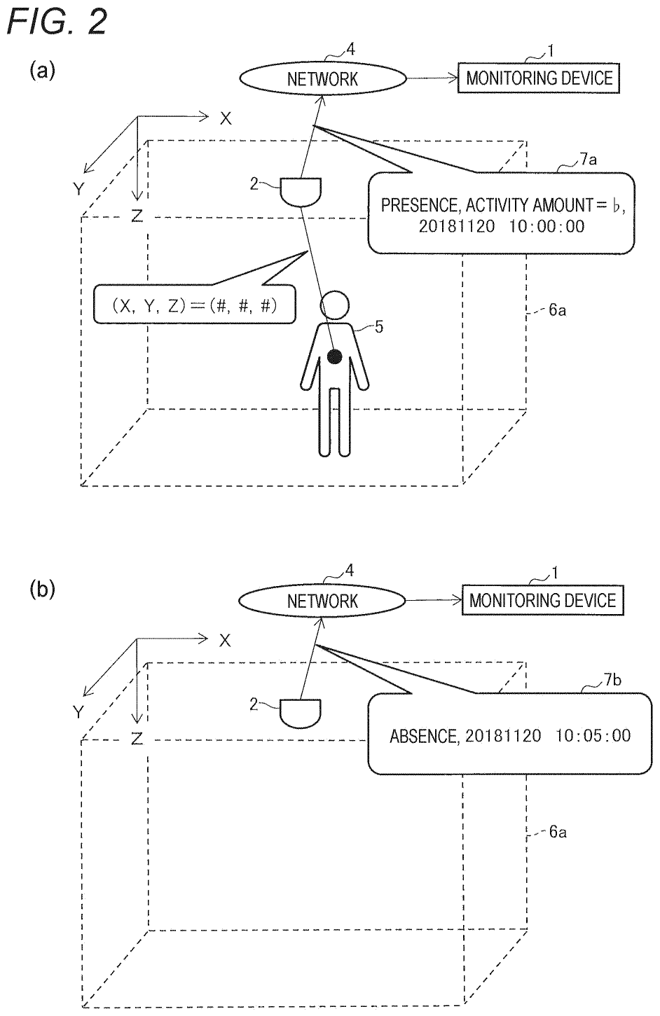

FIGS. 2(a) and 2(b) are diagrams for explaining the information acquired by the sensor 2. The sensor 2 is, for example, a three-dimensional camera. The three-dimensional camera acquires whether the monitored person 5 is in the living room 6a and three-dimensional coordinates of the center position of gravity (which may be the position of the head) when the monitored person 5 is in the living room 6a. Then, the sensor 2 obtains the activity amount based on the three-dimensional coordinates. In FIG. 2(a), the monitored person 5 is in the living room 6a. At this time, the sensor 2 transmits the information “presence” indicating that the monitored person 5 is in the living room 6a, an activity amount b, and the year, month, day, hour, minute, and second (Symbol 7a) of the time when these have been generated to the monitoring device 1 via the network 4 in real time.

In FIG. 2(b), the monitored person 5 is not in the living room 6a. At this time, the sensor 2 transmits the information “absence” indicating that the monitored person 5 is not in the living room 6a, and the year, month, day, hour, minute, second (Symbol 7b) of the time when these have been generated to the monitoring device 1 via the network 4 in real time.

While the details will be described later, the three-dimensional coordinates are information for the sensor 2 to calculate the activity amount of the monitored person 5. The sensor 2 may measure the amount of heat generated by the monitored person 5, minute movements of the body, and the like in a non-contact manner. After all, if the monitoring device 1 can know “presence”, “absence”, the activity amount, and the time when these have been acquired based on the information acquired by the sensor 2, any type of the sensor 2 may be used.

In general, the monitored person 5 dislikes leaking their footage to others, including relatives. Therefore, the sensor 2 does not transmit the video to the monitoring device 1 even if the video of the monitored person 5 can be acquired. Only data other than video (Symbols 7a and 7b) is transmitted.

When the sensor information acquisition unit 21 acquires the information from the sensor 2, the sensor information processing unit 22 processes the information at that time, stores the necessary information, and transmits the information to the terminal device 3. When the sensor information processing unit 22 receives “presence” or “absence” information from the sensor 2, the sensor information processing unit 22 stores the time when “presence” is changed to “absence” and the time when “absence” is changed to “presence” in the state information 32. That is, the sensor information processing unit 22 stores the time point when “presence” and “absence” change. When the information from the sensor 2 is “presence”, the sensor information processing unit 22 stores the time and the activity amount. Then, the sensor information processing unit 22 transmits, to the terminal device 3 of the monitoring person (described later), the reason why the person is in the living room and the activity amount if the person is “presence”, and the reason why the person is not in the living room if the person is “absence” together with the time. The “presence” or “absence” information from the sensor is not used after being processed by the sensor information processing unit 22 described below.

(Information from Sensor)

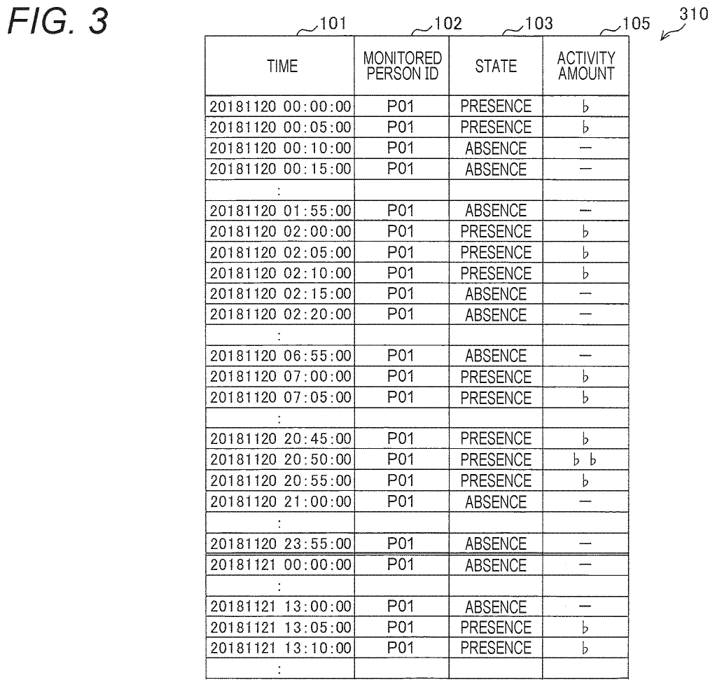

Next, what can be understood based on the information from the sensor 2 will be described. FIG. 3 is a diagram illustrating an example of information 310 from the sensor 2. The sensor transmits the ID of the monitored person, the state of the monitored person, and the activity amount of the monitored person in association with the time.

The time in the time column 101 represents the year, month, day, hour, minute, and second at the time point when the sensor 2 acquires the information of Symbol 7a in FIG. 2(a) or the information of Symbol 7b in FIG. 2(b). In this embodiment, the sensor 2 acquires this information every 5 minutes.

The monitored person ID in a monitored person ID column 102 represents an identifier that uniquely specifies the monitored person. In the example of FIG. 3, only “P01” is described for simplification of explanation. However, the monitoring device 1 can simultaneously execute processing for a plurality of monitored persons.

The state of a state column 103 is either “presence” indicating that the monitored person 5 is in the living room 6a, or “absence” indicating that the monitored person 5 is not in the living room 6a.

The activity amount in an activity amount column 105 indicates a value quantified by measuring the activity state of the monitored person by the sensor 2. In the activity amount column 105 whose state is “absence”, “-” indicating that there is no information is noted. In the activity amount column 105 in which the state is “presence”, “b” indicates a different value in abbreviated form. “b b” indicates that the value is an abnormal value that is not normally expected (details below).

Referring FIG. 3, we can see the following.
From 00:00:00 to 00:05:00 on Nov. 20, 2018, the monitored person P01 was in the living room 6a.
From 00:10:00 to 01:55:00, the monitored person P01 was not in the living room 6a. During this time, the monitored person P01 is highly likely to have been in bedroom 6b.
From 02:00:00 to 02:10:00, the monitored person P01 was in the living room 6a. During this time, it is highly probable that the monitored person P01 waked up and passed through the living room 6a to go to the bathroom, or was unable to fall asleep and was in the living room.
From 02:15:00 to 06:55:00, the monitored person P01 was not in the living room 6a. During this time, the monitored person P01 is highly likely to have been in bedroom 6b.
From 07:00:00 to 20:55:00, the monitored person P01 was in the living room 6a.
From 21:00:00 on Nov. 20, 2018 to 13:00:00 on Nov. 21, 2018, the monitored person P01 was not in the living room 6a. During this time, the monitored person P01 seems to have been in the bedroom 6b at first glance, but it is highly possible that he was out to a relative's house, for example. A horizontal double line indicates that the date has changed.
From 13:05:00 to 13:10:00, the monitored person P01 was in the living room 6a.
The monitored person P01 was doing some activity when he/she was in the living room 6a. This activity is highly possible to be an activity such as cleaning the inside of the living room 6a, getting up from the sofa and going to the window to look at the garden, and going to the table from the window and eating during the day, and an activity such as reading on the sofa and passing through the living room 6a to go to the restroom during night.
The activity amount at 20:50:00 on Nov. 20, 2018 is an abnormal value. At this time, it is highly possible that a pet sleeping in the corridor entered the living room 6a and ran around, and the laundry of the neighbor entered through the window, which was completely unrelated to the activities of the monitored person 5.

The monitoring person who knows these will have the following concerns 1 to 3, for example.

<Concern 1> The monitored person 5 may have gone to bedroom 6b but could not easily fall asleep. If so, the monitored person is probably running out of sleep, just like doing something in the living room 6a.

<Concern 2> The monitored person 5 may have stayed at someone's house during night. If so, it would be good if the monitored person slept well and well at the house, but may have run out of sleep and bothered the house.

<Concern 3> The activity amount of the monitored person 5 at a certain time is clearly abnormal. This abnormal value may be the result of incorporating some external factor. If so, there is no need to worry, but if not, there may be an unexpected symptom of the disease.

It is a feature of the monitoring device 1 of this embodiment that the above-mentioned concerns are resolved, or even if the concerns are not resolved, the monitoring person does not have excessive concerns.

(State Information)

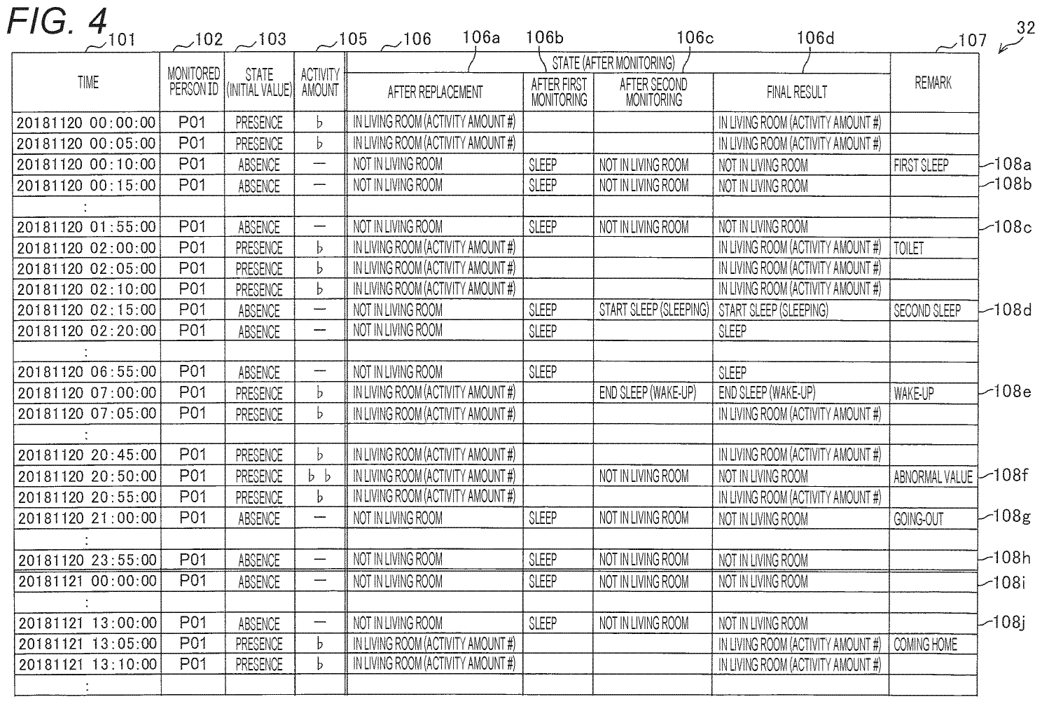

FIG. 4 is a schematic diagram illustrating an example in which the sensor information processing unit 22 processes the sensor information and stores the processed information in the state information 32. The left side of the vertical double line of the state information 32 is the same as the information 310 (FIG. 3) from the sensor. However, the data actually stored is the data in the column on the right side of the double line corresponding to the time when the state changes for each monitored person ID. In association with the time stored in the time column 101, the state (post-review) column 106 describes the state (post-review), and a remark column 107 describes the description. The state (post-review) column 106 is further configured by a post-replacement column 106a, a first post-review column 106b, a second post-review column 106c, and a final result column 106d. The post-replacement column 106a, the first post-review column 106b, the second post-review column 106c, and the final result column 106d are the information transmitted to the monitoring person's terminal device 3 together with the time.

“Post-review” in the word “state (post-review)” is paired with “initial value” in the word “state (initial value)”. However, in the following, in order to avoid complication of expression, “(post-review)” in the word “state (post-review)” is omitted unless misleading. Note that “review” means deleting certain information and replacing it with other information, or correcting or compensating certain information with other information. The monitoring device 1 executes replacement (simple conversion to words for the user), first review, and second review (correction that reflects meaning of absence) so as to extract an activity which can be evaluated as “sleep” from “absence” especially during night.

(Replacement)

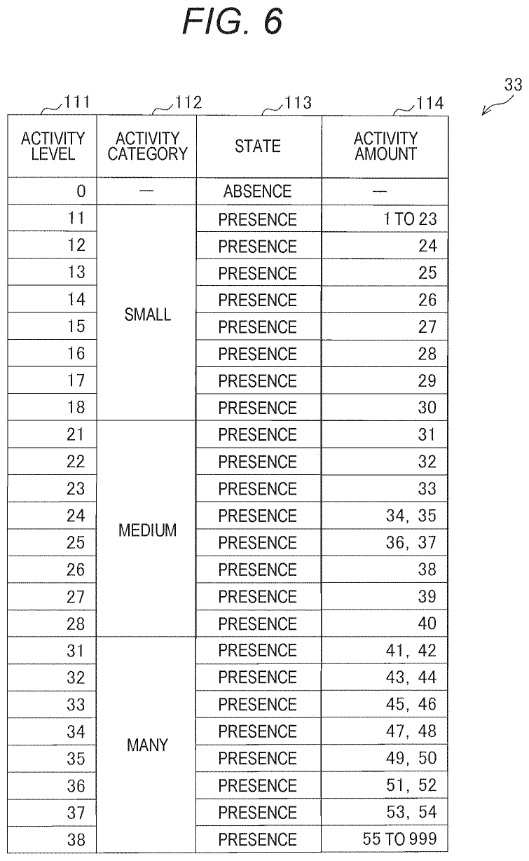

The state of the post-replacement column 106a is either “in the living room (activity amount #)” or “not in the living room”. The sensor information processing unit 22 of the monitoring device 1 replaces the state (initial value) of the state (initial value) column 103 in accordance with the following Rules 1 and 2. “#” indicates a different value abbreviated.

<Rule 1> When the state (initial value) is “absence”, the sensor information processing unit 22 replaces it with “not in the living room”.

<Rule 2> When the state (initial value) is “presence”, the sensor information processing unit 22 acquires the activity amount. Then, the sensor information processing unit 22 applies the acquired activity amount to the activity level information 33 (described later with FIG. 6) to acquire the corresponding activity category. The activity category acquired here is any one of “small”, “medium”, and “many”. The sensor information processing unit 22 classifies any of “in the living room (small activity amount)”, “in the living room (medium activity amount)”, and “in the living room (many activity amount)” as the state after replacement depending on the acquired activity category. In other words, “in the living room (activity amount #)” in FIG. 4 shows these three types of states in an abbreviated and representative manner.

(First Review)

The state of the first post-review column 106b is either “sleep”, “in the living room (activity amount #)” or “not in the living room”. The blank in the post-review column 106b indicates “same as left” (details will be described later). The sensor information processing unit 22 reviews the state of the post-replacement column 106a in accordance with the following Rules 11 and 12.

<Rule 11> The sensor information processing unit 22 determines whether the information received from the sensor 2 is “absence” and the time is included in a night operation time zone (from 18:00 on the day to 4:00 on the next day). If the result of the determination is “Yes”, the sensor information processing unit 22 further classifies the following cases.

The sensor information processing unit 22 stores the time when “presence” information from the sensor 2 changes to “absence” during the night operation time zone. After this change, if “absence” is transmitted continuously for a predetermined number of times (for example, 12 times for 1 hour) instead of “presence”, the sensor information processing unit 22 reviews all continuous “not in the living room” as “sleep”. In other words, the sensor information processing unit 22 once assumes the fact that the monitored person was not in the living room during night as “sleep” that is positive for his health.

That is, when “presence” is transmitted during the night operation time zone and then changes to “absence” instead of “presence”, the sensor information processing unit 22 stores the time. After that, when “absence” is continuously transmitted a predetermined number of times (for example, 12 times for 1 hour) (counted by a counter), the sensor information processing unit 22 sets a “sleep flag” in association with the stored time. Then, the sensor information processing unit 22 determines that all “not in the living room” after the sleep flag are “sleep”. In this case, the sensor information processing unit 22 deletes the information itself of “not in the living room” after the time when the sleep flag is set, and reviews “not in the living room” after the time when the sleep flag is set to “sleep”, and rewrites the display of the terminal device 3 from “not in the living” to “sleep”.

In other cases, the sensor information processing unit 22 maintains “not in the living room” as the state of the first post-review.

In the above example, the sensor information processing unit 22 sets the sleep flag at the change time when the “absence” continues a predetermined number of times. However, the sensor information processing unit 22 may set the sleep flag and a flag for disabling this sleep flag at the time point of change, and turn off the flag for invalidating the sleep flag when “absence” continues a predetermined number of times so as to validate the sleep flag.

<Rule 12> When the sleep flag is set, and the information from the sensor 2 is changed from “absence” to “presence” in the intermediate time zone (from 4:00 to 12:00), which is the time zone after the night operation time zone, the sensor information processing unit 22 determines “wake-up” (108e), records the time, and transmits the fact to the terminal device 3. The rule is to identify the start and end of the state “sleep”.

In addition, in the first post-review column 106b in FIG. 4, the note of “in the living room (activity amount #)” that was maintained as it is omitted. This is to interpret that “in the living room (activity amount #)” is the fact that the monitored person was in the living room regardless of whether it was daytime or nighttime. The sensor information processing unit 22 does not review “in the living room (activity amount #)”. The blank in the first post-review column 106b means “same as left” (the same applies to the second post-review column 106c).

(Second Review)

The state in the second post-review column 106c is any of “sleep”, “in the living room (activity amount #)”, “not in the living room”, “start of sleep (sleeping)” and “end of sleep (wake-up)” (blank indicates “same as left”). The sensor information processing unit 22 reviews the state of the first post-review column 106b in accordance with the following Rules 21 to 24.

<Rule 21> When the information received from the sensor 2 is “presence” and the activity amount received along with it is “b b”, the sensor information processing unit 22 reviews it as “not in the living room” instead of “in the living room (activity amount #)” (108f). In other words, the abnormal value is clearly ignored in order not to give unnecessary concern to the monitoring person.

<Rule 22> When, in the state that the sleep flag is set, “presence” is sent from the sensor 2 in the night operation time zone, and the “presence” continues a predetermined number of times (for example, 3 times 15 minutes), the sensor information processing unit 22 reviews “sleep” in front of “in the living room (activity amount #)” as “not in the living room” (108a to 108c). The sensor information processing unit 22 leaves the sleep flag as it is, and sets a flag indicating that the sleep flag is invalid. At this time, the sensor information processing unit 22 also rewrites the display of the terminal device 3 from “sleep” to “not in the living room”.

If the number of times of “presence” is less than a predetermined number of times, the sensor information processing unit 22 continues “sleep” without setting the invalid flag. The sensor information processing unit 22 determines that the monitored person intends to go to bed soon because it is “presence” for a short time, and continues the “sleep” state. However, the sensor information processing unit 22 displays “in the living room (activity amount #)” together with “sleep” on the terminal device 3. In addition, the sensor information processing unit 22 also includes this short-term “presence” in a monthly sleep time and a weekly sleep time, as will be described later.

After that, the sensor information processing unit 22 makes a determination of Rule 11, determines that it is “sleep” again, and if it is considered that the monitored person has made “first sleep” and “second sleep”, only the second sleep is evaluated as sleep.

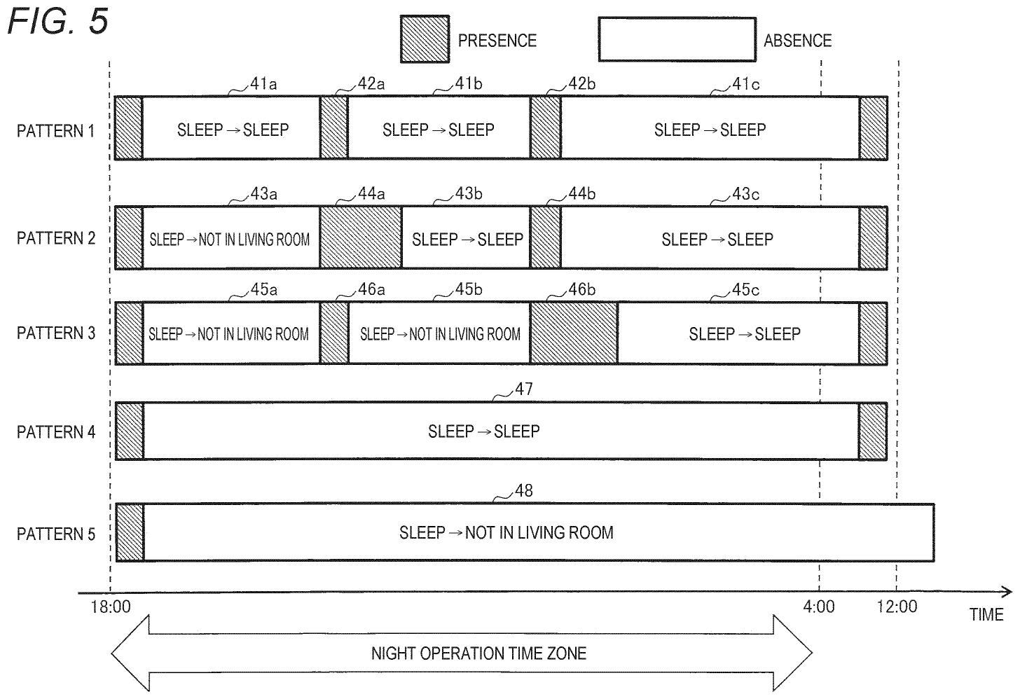

The case where there are three or more “sleep” groups will be described later in FIG. 5.

<Rule 23> According to Rule 11, when “sleep” is determined after entering in the night operation time zone, no “presence” occurs then, and as a result, it was not determined the monitored person woke up before 12:00 the next day, the sensor information processing unit 22 reviews “sleep” at that time as “not in the living room” (108g to 108j). That is, the sensor information processing unit 22 does not evaluate the monitored person as “sleep” when it seems that the monitored person has gone out during night.

<Rule 24> If the first sleep is not evaluated as sleep after processing according to Rules 21 to 23, the sensor information processing unit 22 reviews “sleep” at the time when the sleep flag is set twice as “start sleep (sleeping)” among “sleep” continuous in the first post-review column 106b (108d). On the other hand, if the first sleep is evaluated as sleep after processing according to Rules 21 to 23, the sensor information processing unit 22 reviews “sleep” at the time when the sleep flag is set once as “start sleep (sleeping)” among “sleep” continuous in the first post-review column 106b (not illustrated).

(Final Result)

The sensor information processing unit 22 stores the final state as the final result in the column 106d after performing the replacement, the first review, and the second review. The remark column 107 describes the actions of the monitored person exclusively for the purpose of understanding the invention, and is not the data generated by the monitoring device 1.

(Supplementary Explanation of Second Review)

FIG. 5 is a conceptual diagram further explaining the second review. The horizontal axis in FIG. 5 is time. In the drawing, the night operation time zone is from 18:00 on the day to 4:00 on the next day. The shaded rectangle indicates that the state (initial value) at that time is “presence” in the living room 6a, and is called “presence zone”. The white rectangle indicates that the state (initial value) at that time is “absence” that was not in the living room 6a, and is called “absence zone”. The width of the presence zone indicates the number of pieces of “presence”, which is the state (initial value) in FIG. 4, arranged continuously in the vertical direction. The width of the absence zone indicates the number of pieces of “absence”, which are the states (initial values) in FIG. 4, arranged continuously in the vertical direction.

“Sleep->sleep” or “sleep->not in the living room” is described in the absence zone. Before “->” is the state of the first post-review, and after “->” is the state of the second post-review. Although not illustrated, if an absence zone appears in a time zone other than the night operation time zone, the absence zone is maintained as “not in the living room” (not subject to review). Hereafter, an example of the second review during night will be explained by dividing it into five typical patterns.

<Pattern 1> Absence zones 41a, 41b and 41c sandwich the presence zones 42a and 42b. In reality, the sensor information processing unit 22 maintains the “sleep” of 41a because “presence” has not been continuous for 15 minutes or more. Here, in order to make the explanation easier to understand, it is expressed as “sandwich” (hereinafter, the same applies). The widths of the presence zones 42a and 42b are both less than a predetermined threshold (for example, 15 minutes). At this time, the sensor information processing unit 22 maintains “sleep” for the absence zones 41a, 41b, and 41c. In addition, there are presence zones on the immediate left side of the absence zone 41a and on the immediate right side of the absence zone 41c. This represents the presence zone required as a condition for determining “sleep” (the same applies to the subsequent patterns 2 to 4).

<Pattern 2> Absence zones 43a, 43b, and 43c sandwich the presence zones 44a and 44b. The width of the presence zone 44a is equal to or greater than a predetermined threshold, and the width of the presence zone 44b is less than the predetermined threshold. At this time, the sensor information processing unit 22 maintains “sleep” for the absence zones 43b and 43c, and reviews “sleep” for the absence zone 43a to “not in the living room”.

<Pattern 3> Absence zones 45a, 45b, and 45c sandwich the presence zones 46a and 46b. The width of the presence zone 46a is less than the predetermined threshold, and the width of the presence zone 46b is greater than or equal to the predetermined threshold. At this time, the sensor information processing unit 22 maintains “sleep” for the absence zone 45c, and reviews “sleep” for the absence zones 45a and 45b to “not in the living room”.

<Pattern 4> The left end of the absence zone 47 is after 18:00, and the right end is after 4:00 and before 12:00. At this time, the sensor information processing unit 22 maintains “sleep” for the absence zone 47. An example of an extremely long absence zone is shown as pattern 4, but “sleep→sleep” is described for the absence zone that starts after 18:00 and exceeds 4:00 the next morning (the same applies to the absence zones 41c, 43c, and 45c).

<Pattern 5> The left end of the absence zone 48 is after 18:00, and the right end is after 12:00. At this time, the sensor information processing unit 22 reviews “sleep” to “not in the living room” for the absence zone 48. In addition, there is a presence zone just to the left of the absence zone 48. This is because, regarding the determination of the start of a state that seems to be sleep, if there are 12 consecutive “absences” immediately after “presence” during the night operation time zone, the time when it changes to “absence” is the start of sleep. On the other hand, there is no presence zone just to the right of the absence zone 48. This means that the presence has not been confirmed at this time point.

(Activity Level Information)

FIG. 6 is a diagram illustrating an example of the activity level information 33. In the activity level 33, the activity category is stored in the activity category column 112, the status is stored in the state column 113, and the activity amount is stored in the activity amount column 114 in relation to the activity level stored in the activity level column 111.

The activity level in the activity level column 111 is an identifier that uniquely identifies the level of the activity amount. By the way, the activity level “0” corresponds to the state “absence”. Other activity levels are two-digit numbers, with the tens digits “1”, “2”, and “3” corresponding to the activity categories “small”, “medium” and “many”, respectively. The one-digit numbers “1” to “8” indicate the order in which the activity amounts are arranged in ascending order in each activity category.

The activity category in the activity category column 112 is any one of “small”, “medium”, and “large”, in which the level of activity amount is classified into three stages.

The state of the state column 113 is the same as the state of FIG. 3.

The activity amount in the activity amount column 114 is the same as the activity amount in FIG. 3, but here it is a specific numerical value. The user can arbitrarily select the type of activity amount (moving distance, calorific value, etc.). The value of the activity amount here merely indicates that the activity amount gradually increases from top to bottom. The activity amount is stored in association with the time when “presence” is received.

(Current State Display Processing Procedure)

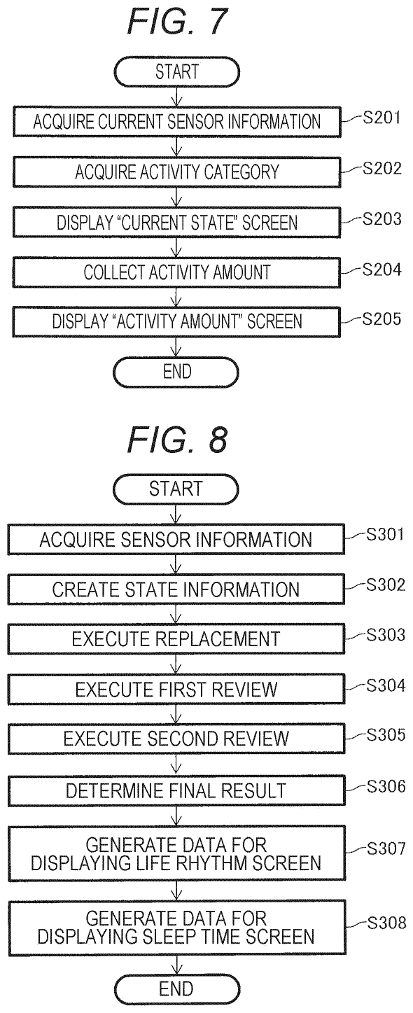

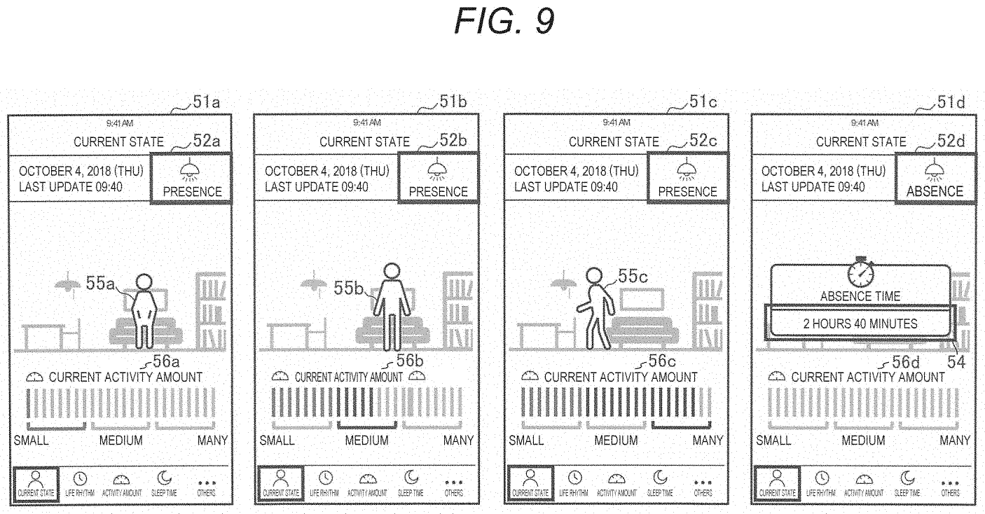

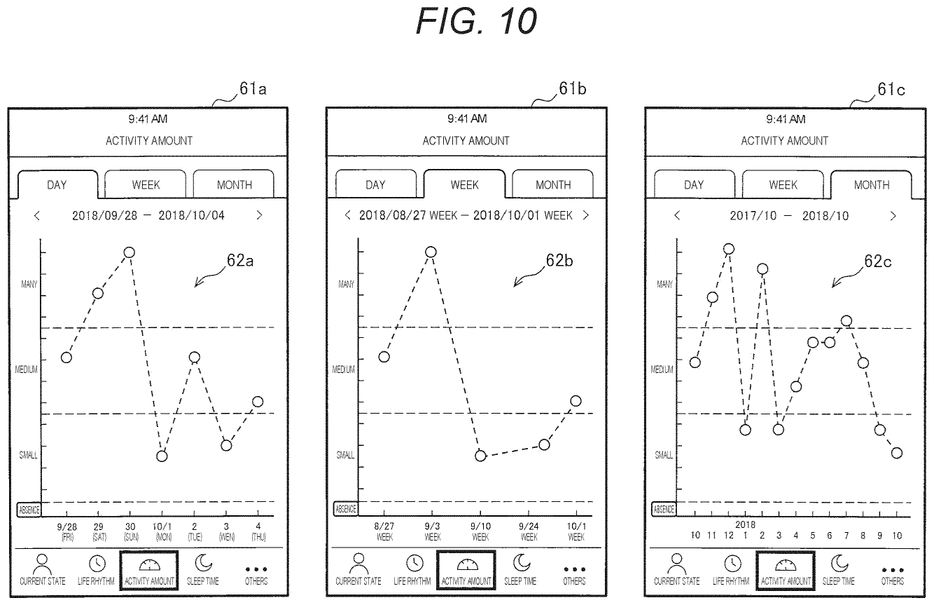

FIG. 7 is a flowchart of the current state display processing procedure. In the description, FIGS. 9 and 10 will be referred as appropriate.

In Step S201, the sensor information acquisition unit 21 of the monitoring device 1 acquires the current sensor information. Specifically, the sensor information acquisition unit 21 acquires the latest state of the information 310 (FIG. 3) from the sensor.

In Step S202, the sensor information acquisition unit 21 acquires the activity category. Specifically, the sensor information acquisition unit 21 acquires the corresponding activity category from the activity level information 33 (FIG. 6) based on the state and activity amount acquired in Step S201. When the state acquired in Step S201 is “absence”, the sensor information acquisition unit 21 counts up every time when receiving the “absence” information in order to measure the period during which “absence” is continuous (referred to as “absence time”).

In Step S203, the sensor information processing unit 22 of the monitoring device 1 displays the “current state” screen 51 (FIG. 9, Symbols 51a to 51d) in the terminal device 3 of the monitoring person. Specifically, first, the sensor information processing unit 22 generates the “current state” screen 51 based on the state, the activity amount, the activity category, and the absence time. An example of the case where the state acquired in Step S201 is “presence” is the “current state” screens 51a to 51c. The “current state” screens 51a to 51c have “presence” columns 52a to 52c. Further, the “current state” screens 51a to 51c may have icons 55a to 55c illustrating the state of movement of the monitored person against the background of the living room and graphs 56a to 56c illustrating the activity amount.

For example, the “current state” screen 51a indicates that the activity amount of the monitored person is “small” by the icon 55a in which the monitored person is sitting in the living room. Similarly, the “current state” screen 51b indicates that the activity amount of the monitored person is “medium” by the icon 55b in which the monitored person is standing on the floor of the living room. The “current state” screen 51c indicates that the activity amount of the monitored person is “many” by the icon 55c in which the monitored person is walking in the living room.

An example of the case where the state acquired in Step S201 is “absence” is the “current state” screen 51d. The “current state” screen 51d has a “absence” column 52d and an absence time column 54. Further, the “current state” screen 51d may have a graph 56d illustrating the activity amount (“0”). Then, the “current state” screen 51d indicates that the monitored person is not in the living room by not displaying the icon indicating the monitored person.

Secondly, the sensor information processing unit 22 transmits the data to be displayed as the generated “current state” screen 51 to the terminal device 3 and displays it.

In Step S204, the sensor information processing unit 22 aggregates the activity amount. Specifically, the sensor information processing unit 22 aggregates the daily, weekly, and monthly activity amounts using the information 310 (FIG. 3) from the sensor.

In Step S205, the sensor information processing unit displays an activity amount screen 61 (FIG. 10). Specifically, first, the sensor information processing unit 22 uses the daily activity amount, the weekly activity amount, and the monthly activity amount to generate a daily activity amount screen 61a, a weekly activity amount screen 61b, and a monthly activity amount screen 61c, respectively. The activity amount screens 61a to 61c have line graphs 62a to 62c illustrating the activity amount in chronological order.

Secondly, the sensor information processing unit 22 transmits and displays the data to be displayed as the generated activity amount screens 61a to 61c to the terminal device 3 according to the selection of the monitoring person.

After that, the current state display processing procedure ends.

(Life Rhythm/Sleep Time Display Processing Procedure)

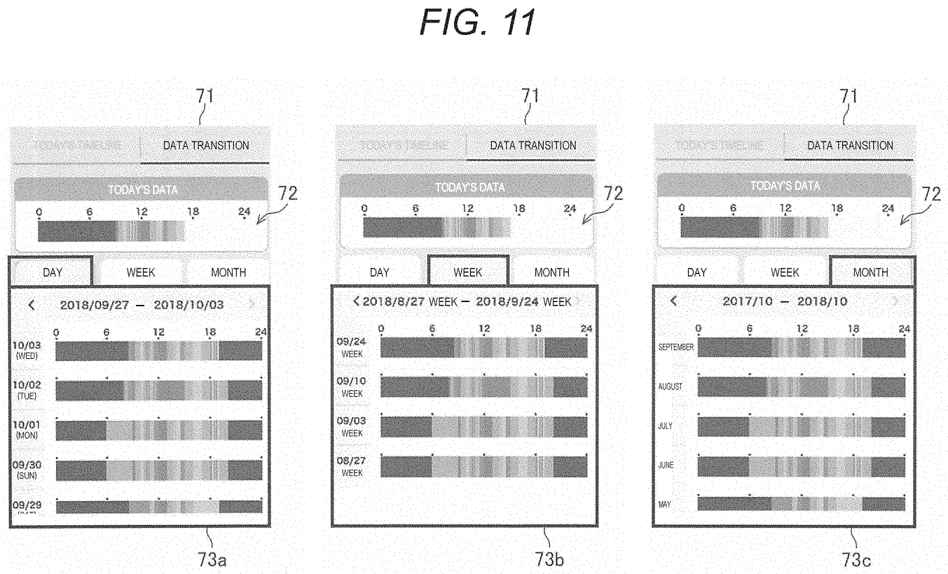

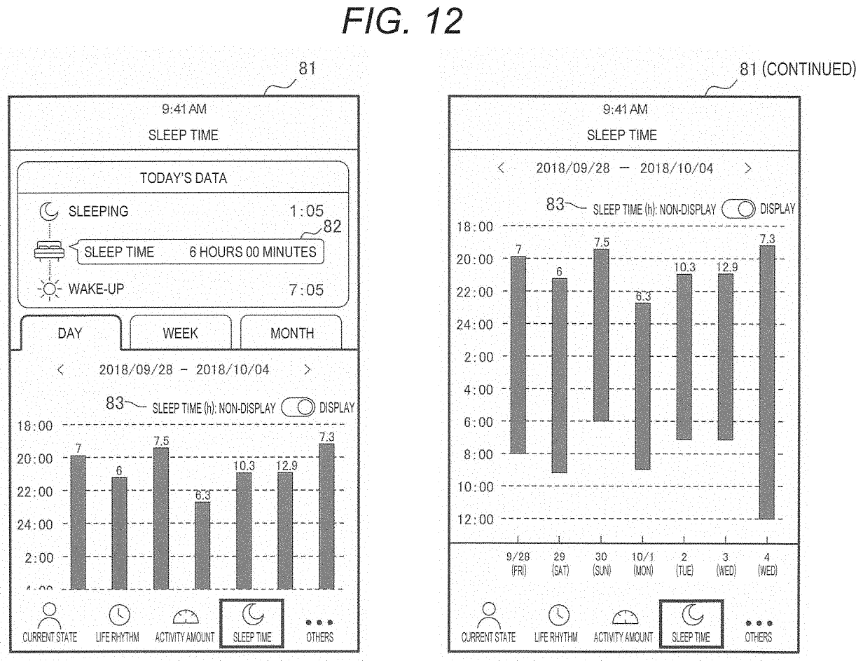

FIG. 8 is a flowchart of the life rhythm/sleep time display processing procedure. In the description, FIGS. 11 and 12 will be referred as appropriate.

In Step S301, the sensor information acquisition unit 21 of the monitoring device 1 acquires the sensor information transmitted from the sensor 2. When the acquired information changes from the previous state, the sensor information acquisition unit 21 stores the time. When the information changes to “presence”, the sensor information acquisition unit 21 stores the activity amount in association with the time. When the information changes to “absence”, the sensor information acquisition unit 21 counts up each time “absence” is sent.

In Step S302, the sensor information processing unit 22 of the monitoring device 1 creates the state information 32 (FIG. 4). Specifically, the sensor information processing unit 22 adds a state column 106 (initially blank) to the sensor information acquired in Step S301 to obtain the state information 32 associated with the time.

In Step S303, the sensor information processing unit 22 executes the replacement each time when information is transmitted from the sensor 2. Specifically, the sensor information processing unit 22 executes the replacement according to rules 1 and 2 as described above. At this stage, the post-replacement column 106a of the state information 32 is filled. Here, the sensor information processing unit 22 replaces “absence” with “not in the living room” and “presence” with “in the living room (activity amount #)”.

In Step S304, the sensor information processing unit executes the first review when the above-mentioned predetermined conditions are satisfied. Specifically, the sensor information processing unit 22 executes the first review in accordance with rules 11 and 12 as described above. At this stage, the first post-review column 106b of the state information 32 is filled (including the blank meaning “same as left”). Here, the sensor information processing unit 22 pays attention to the sleep flag and reviews a part of “not in the living room” as “sleep”.

In Step S305, the sensor information processing unit executes the second review when the predetermined conditions are met as in the first review. Specifically, the sensor information processing unit 22 executes the second review in accordance with rules 21 to 24 as described above. Here, the sensor information processing unit 22 pays attention to the invalidated sleep flag (detailed later), and reviews a part of “sleep” as “sleep” again. At this stage, the second post-review column 106c of the state information 32 is filled (including the blank meaning “same as left”).

In Step S306, the sensor information processing unit 22 determines the final result. Specifically, the sensor information processing unit 22 stores the final result as described above. At this stage, the final result column 106d of the state information 32 is filled.

In Step S307, the sensor information processing unit generates data for displaying a life rhythm screen 71 (FIG. 11) on the monitoring person's terminal device 3. Specifically, the sensor information processing unit 22 generates life rhythm data based on the final result stored in Step S306. The life rhythm screen 71 of the terminal device 3 is a band graph 72 of a time-series in which the latest day is color-separated for each of the states (“sleep”, “in the living room (activity amount #), and “not in the living room”) of the final result. The sensor information processing unit 22 can also generate past band graphs on a daily 73a, a weekly 73b, and a monthly 73c.

In Step S308, the sensor information processing unit 22 generates data for displaying a sleep time screen 81 (FIG. 12) on the terminal device 3. Specifically, the sensor information processing unit 22 generates sleep time data based on the final results (“start sleep (sleeping)” and “sleep end (wake-up)”) stored in Step S306. The sleep time screen 81 of the terminal device 3 has a column 82 illustrating the sleep time of today (the night before), and a graph 83 illustrating the sleep time of several days before the previous day and the time zone thereof. The graph 83 should be visually recognized by scrolling long in the vertical direction. The sensor information processing unit 22 can also generate the graph 83 on a daily, weekly, and monthly basis.

Further, the sensor information processing unit 22 does not transmit the life rhythm screen and the sleep time screen to the terminal device 3 at the timings of Steps S307 and S308, but at the timing of the first review and the second review, the screen displayed on the terminal device may be rewritten. That is, instead of the sensor information processing unit 22 creating the screen, the terminal device 3 may sequentially generate the screen based on the information received from the monitoring device 1.

After that, the life rhythm/sleep time display processing procedure is completed.

For example, between 19:00 one day and 11:30 the next day, the monitoring person looked at the “current state” screen several times, and as a result, the monitored person was continuously “sleep” during that time. However, as a result of the monitoring person looking at the life rhythm screen at the time after 12:00 on the next day, it may be turned out that the state of being monitored from 19:00 on the previous day to the present is actually “not in the living room”. This corresponds to pattern 5 in FIG. 5. The sensor information processing unit 22 of the monitoring device 1 may send the following message to the terminal device 3 and display it at the time point when the review of “sleep->not in the living room” is executed. An example of the message is “While not reported in sleep, it was turned out that the monitoring person was not in the living room”.

Next, the terminal device 3 will be briefly described. The drawings and graphs illustrated in FIGS. 9 to 12 are displayed on the terminal device 3, but if these drawings and tables are transmitted from the monitoring device 1 every 5 minutes, for example, a problem such as a long reception occurs. In this embodiment, by downloading a plurality of formats to be displayed based on the data transmitted from the monitoring device 1 when receiving the monitoring service, the display can be performed only by receiving the data.

The drawing or graph is updated when the monitoring person presses the update button (not illustrated).

(Effect of this Embodiment)

The effects of the monitoring device of this embodiment are as follows.

(1) The monitoring device can extract the time zone in which the monitored person seems to be truly sleeping during the period when the monitored person is not in the living room during night.

(2) The monitoring device can acquire the activity amount of the monitored person by classifying it according to its level.

(3) The monitoring device can avoid determining that the period of the first sleep when the monitored person has the first sleep and the second sleep during night is during sleep.

(4) The monitoring device can avoid determining that the monitored person is sleeping during the period when he/she seems to have been out during night.

(5) The monitoring device enables the monitoring person to visually check the sleep time or activity amount of the monitored person on a daily, weekly and monthly basis.

(6) The monitoring device makes it possible to visually recognize the transition of the movement of the monitoring person in one day.

(7) The monitoring device can notify the monitoring person that the review of “sleep->not in the living room” has been performed.

Further, the invention is not limited to the embodiments described above, but includes various modifications. For example, the above-described embodiments have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. It is possible to add, delete, and replace other configurations for a part of the configuration of each embodiment.

### REFERENCE SIGNS LIST

1 monitoring device
2 sensor
3 terminal device
4 network
5 monitored person
11 central control device
12 input device
13 output device
14 main memory device
15 auxiliary storage device
16 communication device
21 sensor information acquisition unit
22 sensor information processing unit
32 state information
33 activity level information
301 information from sensor

1. A monitoring device, comprising:
a sensor information acquisition unit that receives information indicating that a monitored person is in a living room or information indicating that the monitored person is not in the living room from a sensor installed in the living room of a monitored person's house; and
a sensor information processing unit that reviews information acquired by the sensor during night among the information indicating that the monitored person is not in the living room as information indicating that the monitored person is sleeping, and reviews again information satisfying a predetermined condition among the information indicating that the monitored person is sleeping as the information indicating that the monitored person is not in the living room.

2. The monitoring device according to claim 1,
wherein the sensor information acquisition unit acquires an activity amount of the monitored person from the sensor, or calculates an activity amount of the monitored person based on any information acquired from the sensor, and
wherein the sensor information processing unit classifies the information indicating that the monitored person is in the living room into a plurality of categories, based on the activity amount.

3. The monitoring device according to claim 2,
wherein, when the information indicating that the monitored person is in the living room is continuous in chronological order after the information indicating that the monitored person is sleeping, and a time width of the information indicating that the monitored person is in the living room is equal to or greater than a predetermined threshold,
the sensor information processing unit reviews again the information indicating that the monitored person is sleeping as the information indicating that the monitored person is not in the living room.

4. The monitoring device according to claim 3,
wherein, when the information indicating that the monitored person is sleeping is continuous in chronological order until a predetermined time without sandwiching the information indicating that the monitored person is in the living room,
the sensor information processing unit reviews again the information indicating that the monitored person is sleeping as the information indicating that the monitored person is not in the living room.

5. The monitoring device according to claim 4,
wherein the sensor information processing unit aggregates a sleep time or an activity amount of the monitored person daily, weekly, or monthly, and causes a terminal device operated by a monitoring person to display an aggregated result.

6. The monitoring device according to claim 5,
wherein the sensor information processing unit causes the terminal device to display a period when the monitored person is in the living room for each category in a day, and causes the terminal device to display a period when the monitored person is not in the living room and a period when sleeping in a day.

7. The monitoring device according to claim 6,
wherein the sensor information processing unit causes the terminal device to display that information satisfying a predetermined condition among the information indicating that the monitored person is sleeping is reviewed again as the information indicating that the monitored person is not in the living room.

8. A monitoring method of a monitoring device, comprising:
receiving, by a sensor information acquisition unit of the monitoring device, information indicating that a monitored person is in a living room or information indicating that the monitored person is not in the living room from a sensor installed in the living room of a monitored person's house;
reviewing, by a sensor information processing unit of the monitoring device, information acquired by the sensor during night among the information indicating that the monitored person is not in the living room as information indicating that the monitored person is sleeping; and
reviewing again information satisfying a predetermined condition among the information indicating that the monitored person is sleeping as the information indicating that the monitored person is not in the living room.

9. A monitoring program causing a monitoring device to function, comprising:
causing a sensor information acquisition unit of a monitoring device to receive information indicating that a monitored person is in a living room or information indicating that the monitored person is not in the living room from a sensor installed in the living room of a monitored person's house; and
causing a sensor information processing unit of the monitoring device to,
review information acquired by the sensor during night among the information indicating that the monitored person is not in the living room as information indicating that the monitored person is sleeping, and
review again information satisfying a predetermined condition among the information indicating that the monitored person is sleeping as the information indicating that the monitored person is not in the living room.
